(19) United States
(12) Patent Application Publication
(10) Pub. No.: US 2013/0031289 A1
(43) Pub. Date: Jan. 31, 2013

(54) CONNECTING STRUCTURE FOR DETACHABLE ASSEMBLED ELECTRONIC DEVICE AND DETACHABLE ASSEMBLED ELECTRONIC DEVICE HAVING THE SAME

(71) Applicants: Hsin Yeh, Taipei City (TW); Hsiao-Ling Chan, Taipei City (TW); Ting-Kang Ou, Taipei City (TW); Chien-I Lin, Taipei City (TW); Hsin Lu, Taipei City (TW); Yung-Hsiang Chen, Taipei City (TW); Wen-Yi Chiu, Taipei City (TW); Kuan-Yu Chou, Taipei City (TW); Chih-Chien Lin, Taipei City (TW)

(72) Inventors: Hsin Yeh, Taipei City (TW); Hsiao-Ling Chan, Taipei City (TW); Ting-Kang Ou, Taipei City (TW); Chien-I Lin, Taipei City (TW); Hsin Lu, Taipei City (TW); Yung-Hsiang Chen, Taipei City (TW); Wen-Yi Chiu, Taipei City (TW); Kuan-Yu Chou, Taipei City (TW); Chih-Chien Lin, Taipei City (TW)

(73) Assignee: COMPAL ELECTRONICS, INC., Taipei City (TW)

(21) Appl. No.: 13/556,204

(22) Filed: Jul. 24, 2012

Related U.S. Application Data
(60) Provisional application No. 61/511,539, filed on Jul. 25, 2011.

(51) Int. Cl. G06F 13/14

(52) U.S. Cl. 710/303

(57) ABSTRACT

A detachable assembled electronic device includes a portable device having a display interface and a docking station. The docking station includes a docking station main body and a connecting structure. The connecting structure is assembled to the docking station main body to support the portable device, and includes a flexible element and a first section. The first section is wrapped by the flexible element. When the first section is attached to the portable device, the first section and the flexible element are adapted to support the portable device on the docking station main body, and the portable device is adapted to rotate relative to the docking station main body by the bending of the flexible element to form an operation angle.

### CROSS-REFERENCE TO RELATED APPLICATION

This application claims the priority benefit of U.S. provisional application Ser. No. 61/511,539, filed Jul. 25, 2011. The entirety of the above-mentioned patent application is hereby incorporated by reference herein and made a part of this specification.

### BACKGROUND OF THE INVENTION

1. Field of the Invention

The invention relates to a connecting structure and an electronic device having the same, and more particularly, to a connecting structure for a detachable assembled electronic device and a detachable assembled electronic device having the same.

2. Description of Related Art

In current era of information explosion, electronic products are already becoming indispensable in people's daily life, as the electronic technology has continuously been developed, user-friendly electronic products with power functions also constantly have been brought forth the new to replace the old ones. For example, tablet personal computers (tablet PC) have the convenience in use, and even only requiring a tablet personal computer to be placed on the table or the tights with a utilized stylus that is capable of performing a manipulation thereto. In order to enhance the convenience and comfort for operating the tablet personal computers, the electronic devices combined a tablet personal computer and a docking station having an input interface (such as a keyboard module) have been developed.

Currently docking stations are mainly utilized the hinge structure, so that the tablet personal computer assembled to the docking station is capable of rotating relative to the docking station. However, the design method of the hinge structure may increase the thickness of the tablet personal computer combined with the docking station, which does not conform to the current requirement of light-slim electronic products. If it is intended that the tablet personal computer may be expanded or closed to the docking station or have an appropriate tilt angle by the rotating thereof relative to the docking station, then a plurality of hinge structure must be disposed. This manner may also increase the thickness of the tablet personal computer combined with the docking station, and raise the manufacturing cost. Therefore, the design method for the docking station of the tablet personal computer may still need to be improved.

### SUMMARY OF THE INVENTION

The invention is directed to a connecting structure for a detachable assembled electronic device, which may decrease the thickness of the portable device combined with the docking station and cut down on the manufacturing cost.

The invention is directed to a detachable assembled electronic device, which the connecting structure thereof may decrease the thickness of the portable device combined with the docking station and cut down on the manufacturing cost.

The invention provides a detachable assembled electronic device including a portable device having a display interface and a docking station. The docking station includes a docking station main body and a connecting structure. The connecting structure is assembled to the docking station main body to support the portable device, and includes a flexible element and a first section. The first section is wrapped by the flexible element. When the first section is attached to the portable device, the first section and the flexible element are adapted to support the portable device on the docking station main body, and the portable device is adapted to rotate relative to the docking station by the bending of the flexible element to form an operation angle.

The invention provides a connecting structure for a detachable assembled electronic device, which is adapted to assemble to a docking station main body and attach to a portable device having a display interface. The connecting structure for the detachable assembled electronic device includes a flexible element and a first section. The first section is wrapped by the flexible element. When the first section is attached to the portable device, the first section and the flexible element are adapted to support the portable device on the docking station main body, and the portable device is adapted to rotate relative to the docking station by the bending of the flexible element to form an operation angle.

In an embodiment of the invention, the portable device is adapted to close on the docking station main body by the bending of the flexible element.

In an embodiment of the invention, the connecting structure further includes a supporting element wrapped by the flexible element and connected to the first section by the flexible element.

In an embodiment of the invention, the connecting structure further includes a second section, wherein the second section is wrapped by the flexible element and located between the supporting element and the first section.

In an embodiment of the invention, when both the first section and the second section are attached to the portable device, the portable device is adapted to have a first tilt angle by the support of the connecting structure. When the first section is attached to the portable device and the second section is removed from the portable device by the bending of the flexible element, the portable device is adapted to have a second tilt angle by the support of the connecting structure.

In an embodiment of the invention, the flexible element has a first bending portion and a second bending portion. The first bending portion is located between the first section and the second section, and the second bending portion is located between the second section and the supporting element. When the portable device has the first tilt angle, the first bending portion is not bent and the second bending portion is bent. When the portable device has the second tilt angle, both the first bending portion and the second bending portion are bent, and the second bending portion is leaned against the docking station main body.

In an embodiment of the invention, the docking station main body has a third section and the portable device has a magnetic portion. When the portable device has the second tilt angle, the third section is attracted to the magnetic portion.

In an embodiment of the invention, the first section and the second section have a silica gel or a magnetic substance for attaching to the docking station main body.

In an embodiment of the invention, the portable device has two magnetic portions. The first section and the second section are respectively adapted to attach to the two magnetic portions.

In an embodiment of the invention, the first section and the second section are attached to the docking station main body by an adhesion, a pressure or a magnetism.

In an embodiment of the invention, the flexible element has an extension segment. The extension segment extends from a back side of the docking station main body along a bottom surface of the docking station main body, and is fixed on the docking station main body.

In an embodiment of the invention, the connecting structure further includes a latching element, and the latching element is fixed at the extension segment. When the portable device closes on the docking station main body, the latching element is adapted to latch with the portable device.

In an embodiment of the invention, the docking station main body has a slot and the flexible element has an extension segment, the extension segment is inserted into the slot to assemble the flexible element to the docking station main body.

In an embodiment of the invention, the docking station main body includes an input interface.

Based on the above descriptions, the connecting structure of the invention is adapted to be attached to the portable device and support the portable device on the docking station main body, and the portable device is adapted to be rotated by the bending of the flexible element to change the tilt angle or to be closed on the docking station main body. Since the portable device is rotated by the bending of the flexible element, thus it is not required to dispose a hinge structure on the docking station, so as to decrease the thickness of the portable device combined with the docking station and cut down on the manufacturing cost. In addition, the invention replaces the hinge structure with the flexible element to connect the docking station main body and the portable device, therefore, the portable device may be allowed to have more varieties of operation angle and position by the flexural characteristics of the flexible element.

In order to make the features and advantages of the invention more comprehensible, the invention is further described in detail in the following with reference to the embodiments and the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional illustrating a detachable assembled electronic device according to an embodiment of the invention.

FIG. 2 is a side view illustrating a detachable assembled electronic device in FIG. 1.

FIG. 3 is a partial sectional view illustrating a detachable assembled electronic device in FIG. 2.

FIG. 4 is a three-dimensional view illustrating a changed tilt angle of a portable device in FIG. 1.

FIG. 5 is a side view illustrating a detachable assembled electronic device in FIG. 4.

FIG. 6 is a partial sectional view illustrating a detachable assembled electronic device in FIG. 5.

FIG. 7 is a side view illustrating a portable device closed on a docking station main body in FIG. 1.

FIG. 8 is a partial sectional view illustrating a detachable assembled electronic device in FIG. 6.

FIG. 9 is a partial view illustrating a detachable assembled electronic device in FIG. 5.

FIG. 10 is a partial sectional view illustrating a docking station in FIG. 1.

FIG. 11 is a schematic view illustrating a latching element latched with a portable device in FIG. 10.

FIG. 12 is a partial view illustrating a docking station main body and a flexible element according to another embodiment of the invention.

### DESCRIPTION OF THE EMBODIMENTS

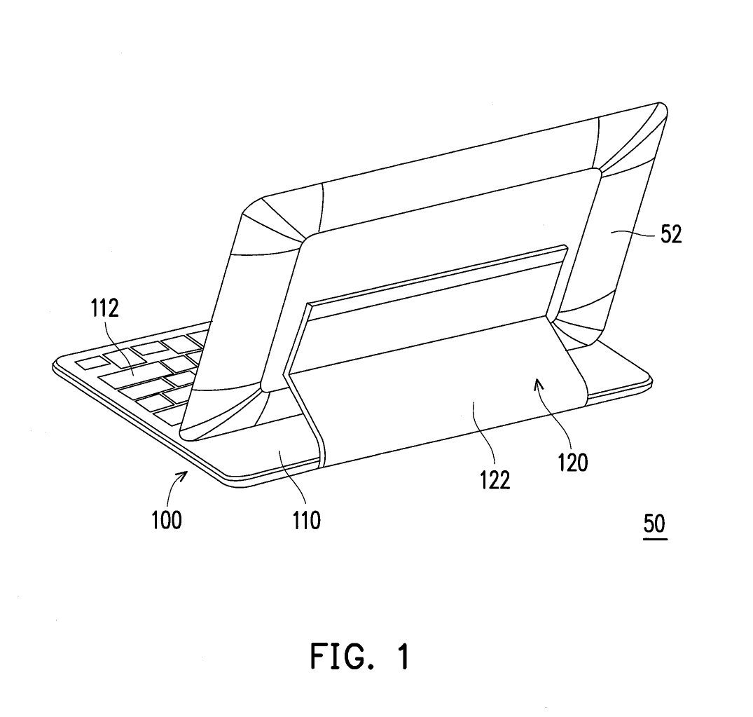

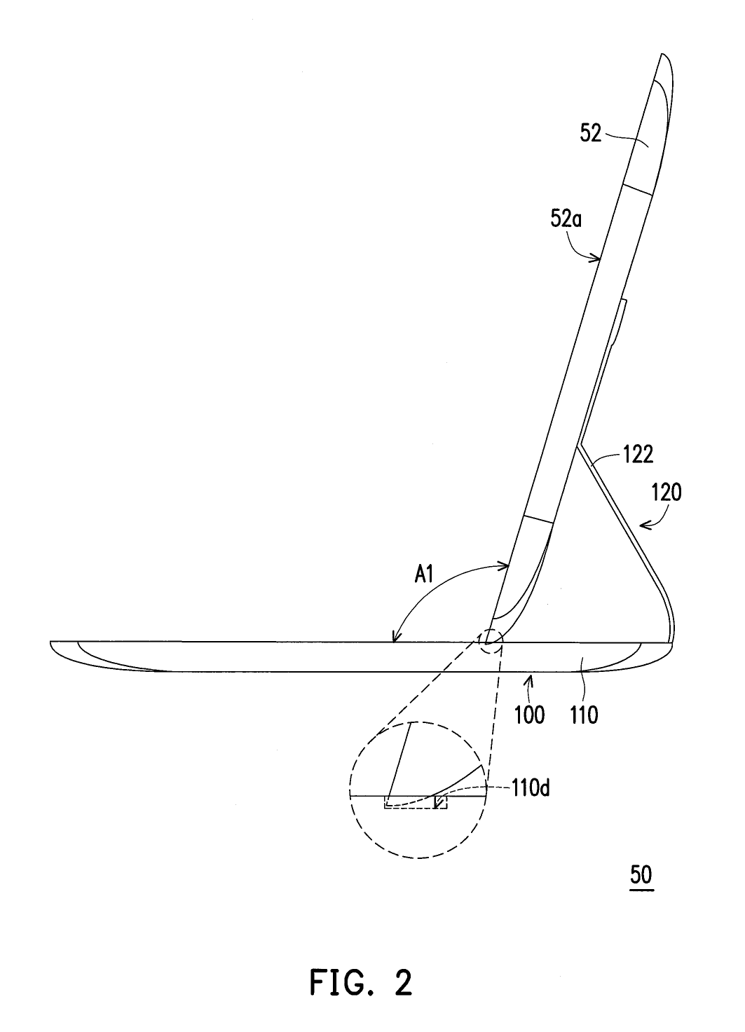

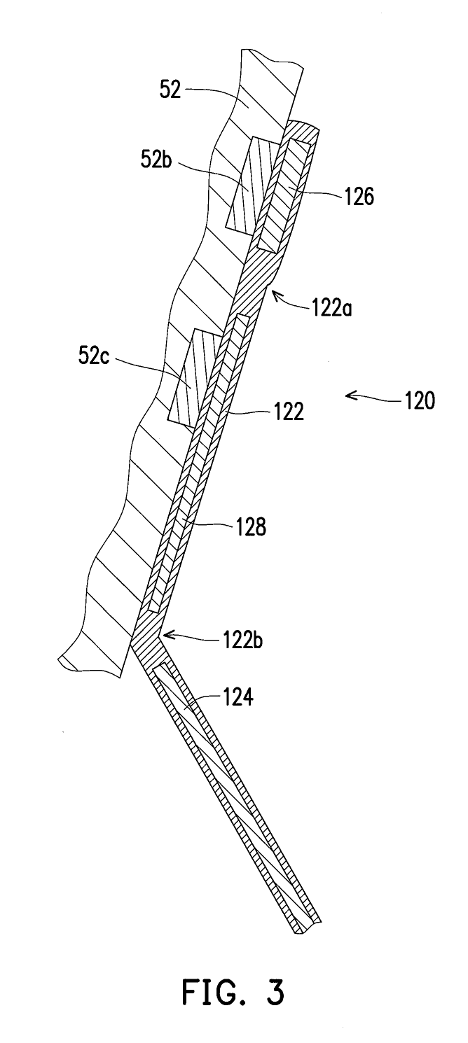

FIG. 1 is a three-dimensional illustrating a detachable assembled electronic device according to an embodiment of the invention. FIG. 2 is a side view illustrating a detachable assembled electronic device in FIG. 1. FIG. 3 is a partial sectional view illustrating a detachable assembled electronic device in FIG. 2. Referring to FIG. 1 to FIG. 3, the detachable assembled electronic device 50 of this embodiment includes a portable device 52 and a docking station 100. The docking station 100 includes a docking station main body 110 and a connecting structure 120. The connecting structure 120 is assembled to the docking station main body 110 to support the portable device 52. The connecting structure 120 includes a flexible element 122, a supporting element 124 and a first section 126. The first section 126 is wrapped by the flexible element 122, the supporting element 124 is wrapped by the flexible element 122 and connected to the first section 126 by the flexible element 122. The portable device 52 may be a, for example, tablet personal computer (tablet PC), and the user may selectively utilize the portable device 52 in a hand-held manner or combine the portable device 52 onto the docking station 100.

When the user is intended to combine the portable device 52 onto the docking station 100, the portable device 52 may approach to the first section 126. When the first section is attached to the portable device 52, the first section 126, the flexible element 122 and the supporting element 124 may support the portable device 52 on the docking station main body 110 of the docking station 100, as shown in FIG. 1 and FIG. 2. The docking station main body 110 may have a positioning slot 110d that is configured to fix the position of the portable device 52, so as to avoid the portable device 52 producing an unexpected slide during the process of utilizing. When the user is intended to utilize the portable device 52 in the hand-held manner, it is only required to remove the portable device 52 from the connecting structure 120, so that the portable device 52 and the docking station 100 are separated.

The docking station main body 110 of the embodiment may comprise an input interface 112 (such as a keyboard module). When the portable device 52 is combined with the docking station 100 to become the state as shown in FIG. 1, a display surface 52a is faced to the user and the input interface 112 is exposed to allow the user to operate the input interface 112 and watch the frame displayed by the display surface 52a conveniently. When the flexible element 122 is bent, the portable device 52 may rotate relative to the docking station main body 110 to form an operation angle. The description is further described in detail in the following with the accompanying drawings.

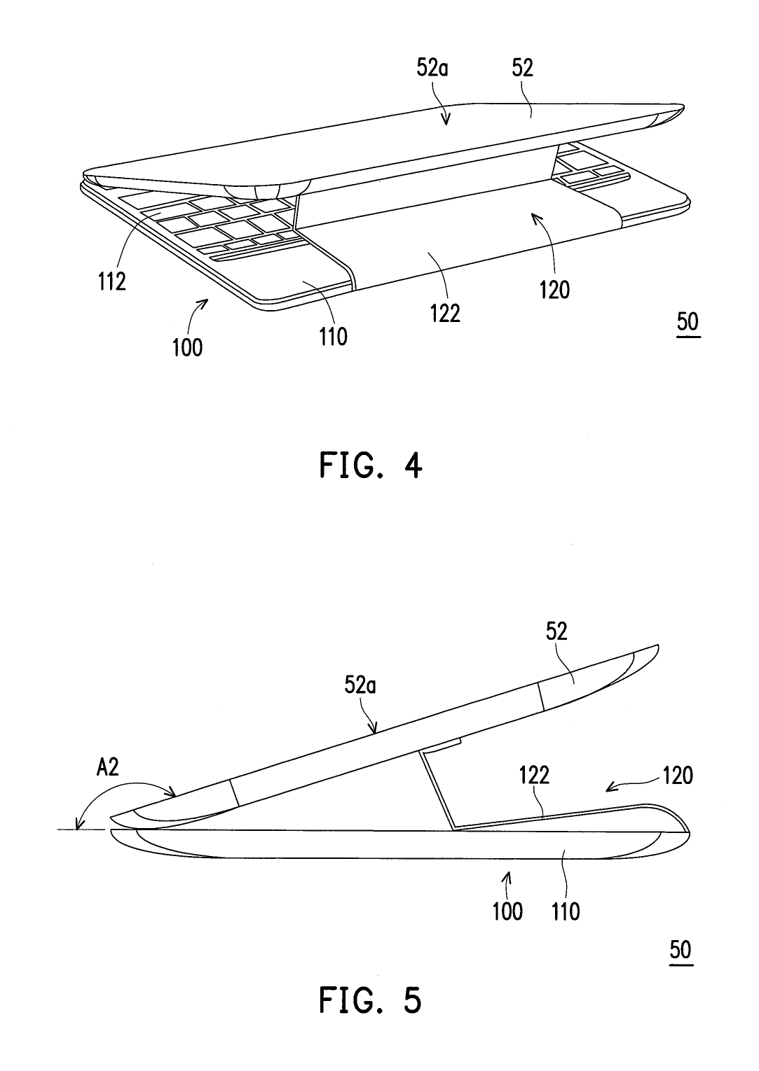

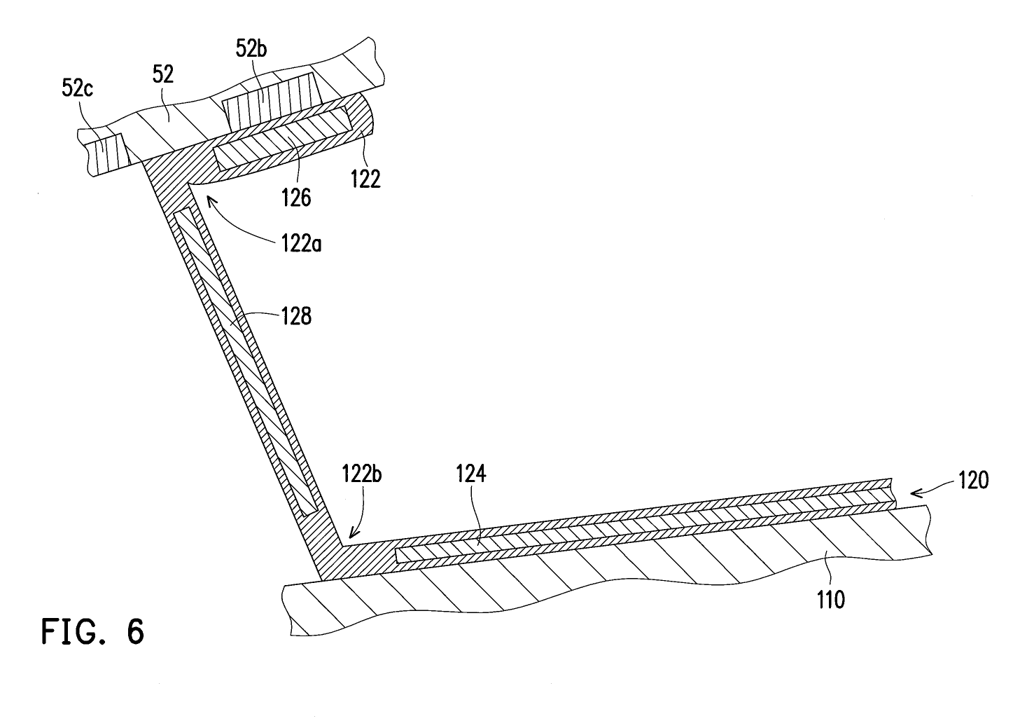

FIG. 4 is a three-dimensional view illustrating a changed tilt angle of a portable device in FIG. 1. FIG. 5 is a side view illustrating a detachable assembled electronic device in FIG. 4. FIG. 6 is a partial sectional view illustrating a detachable assembled electronic device in FIG. 5. When the flexible element 122 is bent to become the state as shown in FIG. 5 and FIG. 6, the tilt angle of the portable device 52 may transform from the state as shown in FIG. 1 to the state as shown in FIG. 4 by the bending of the flexible element 122. At this moment, the display surface 52a of the portable device 52 is further tilted, allowing the user to operate the portable device 52 conveniently in a touch manner

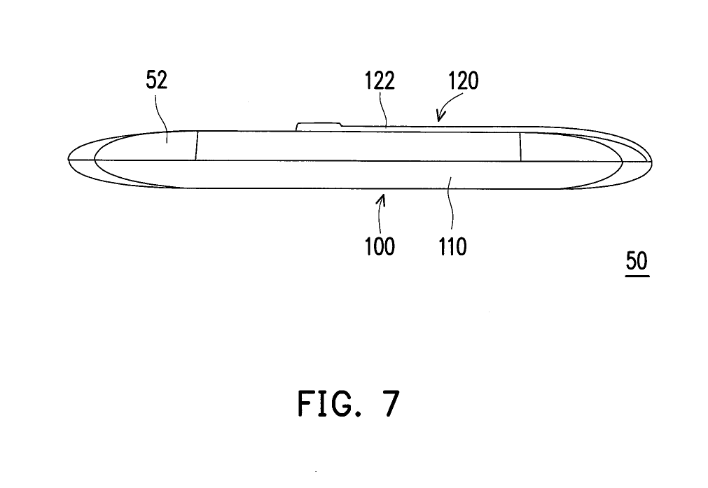

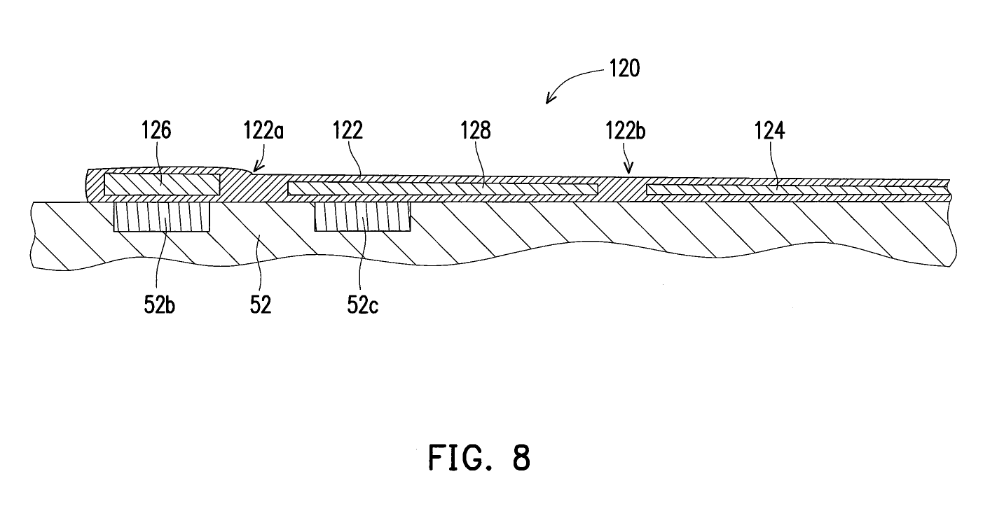

FIG. 7 is a side view illustrating a portable device closed on a docking station main body in FIG. 1. FIG. 8 is a partial sectional view illustrating a detachable assembled electronic device in FIG. 6. When the user is intended to store the electronic device 50 or carry the electronic device 50, the flexible element 122 may be bent to become the state as shown in FIG. 8. At this moment, the portable device 52 may close on the docking station main body 110 as shown in FIG. 7 by the bending of the flexible element 122 to store or carry conveniently.

Under the above-mentioned disposition arrangement, the portable device 52 is rotated by the bending of the flexible element 122, therefore, a hinge structure is not required to dispose on the docking station 100, so as to decrease the thickness of the portable device 52 combined with the docking station 100 and cut down on the manufacturing cost.

Referring to FIG. 3, the connecting structure 120 of the embodiment further includes a second section 128. The second section 128 is wrapped by the flexible element 122 and located between the supporting element 124 and the first section 126. When both the first section 126 and the second section 128 are attached to the portable device 52 as shown in FIG. 3, the portable device 52 is adapted to have a first tilt angle A1 by the support of the connecting structure 120 as shown in FIG. 2. With the disposition of the second section 128, the connecting structure 120 is capable of supporting the portable device 52 on the docking station main body 110 more firmly by fixing the second section 128 and the portable device 52 together, other than by fixing the first section 126 and the portable device 52 together.

Referring to FIG. 6, when the first section 126 is attached to the portable device 52 and the second section 128 is removed from the portable device 52 by the bending of the flexible element 122, the portable device 52 is adapted to have a second tilt angel A2 by the support of the connecting structure 120 as shown in FIG. 5. At this moment, the second section 128 is supported between the portable device 52 and the docking station main body 110, allowing the connecting structure 120 to have sufficient supporting force to support the portable device 52 on the docking station main body 110.

Referring to FIG. 3, in detail, the flexible element 122 of the embodiment has a first bending portion 122a and a second bending portion 122b. The first bending portion 122a is located between the first section 126 and the second section 128, and the second bending portion 122b is located between the second section 128 and the supporting element 124. When the portable device 52 is in the state as shown in FIG. 2 with the first tilt angle A1, the first bending portion 122a is not bent and the second bending portion 122b is bent. When the portable device 52 is in the state as shown in FIG. 5 with the second tilt angle A2, both the first bending portion 122a and the second bending portion 122b are bent, and the second bending portion 122b is leaned against the docking station main body 110.

In this embodiment, the first section 126 and the second section 128 have such as a silica gel or a magnetic substance for attaching to the docking station main body 110. For example, the first section 126 and the second section 128 may be permanent magnets, and the material of the supporting element 124 may be plastic, but the invention is not limited thereto. Other than attached to the docking station main body 110 by the magnetism, the first section 126 and the second section 128 may also be attached to the docking station main body 110 by the adhesion or the pressure. The material of the flexible element 121 may be leather, allowing the connecting structure 120 to have a preferable appearance. In other embodiments, the material of the flexible element 121 may be selected from other appropriate flexible materials, but the invention is not limited thereto. Since the connecting structure 120 is utilized the adhesion, the pressure or the magnetism to attach to the portable device 52, the portable device 52 is adapted to detach from the connecting structure 120 to be in a detachable manner, so as to enhance the agility of utilizing.

Referring to FIG. 3, the portable device 52 of the embodiment has a magnetic portion 52b and a magnetic portion 52c. The magnetic portion 52b and the magnetic portion 52c are respectively corresponding to the first section 126 and the second section 128 of the connecting structure 120. The first section 126 and the second section 128 may be respectively attached to the magnetic portion 52b and the magnetic portion 52c. In other embodiments, the housing of the portable device 52 may be selected from metal materials adapted to be attracted by the magnet, and thus the first section 126 and the second section 128 are capable of being attracted to the housing of the portable device 52. Under such design manner, it may be selected that the magnetic portion 52b and the magnetic portion 52c are not disposed. The magnetic portion 52b and the magnetic portion 52c described above may be such as permanent magnets or other appropriate types of magnetic element.

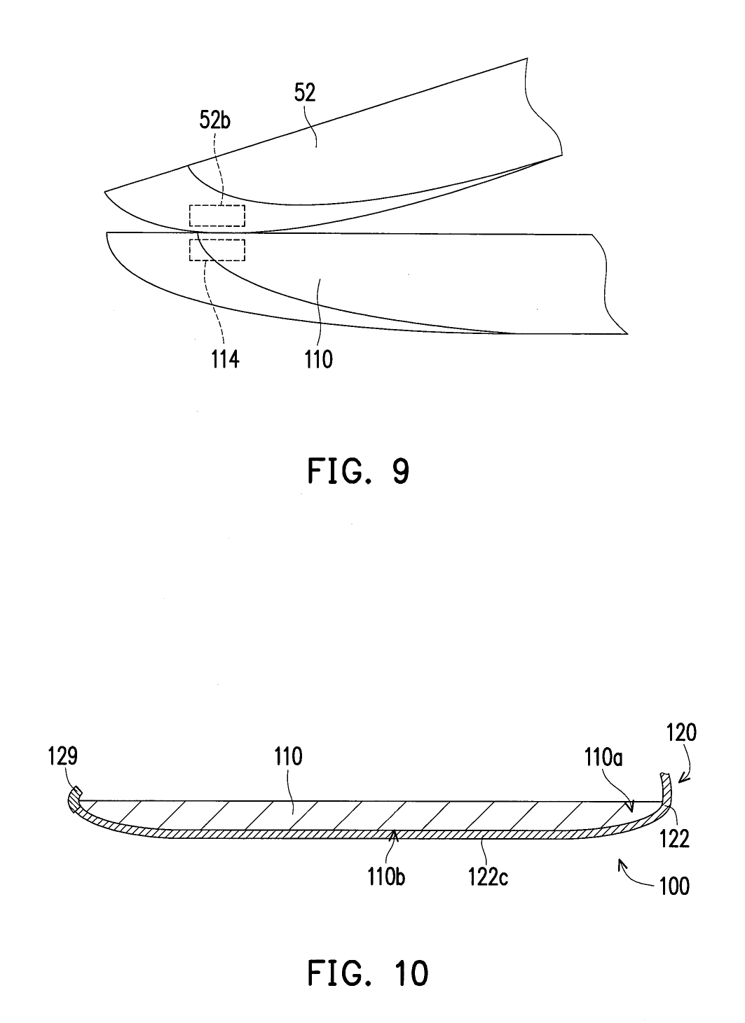

FIG. 9 is a partial view illustrating a detachable assembled electronic device in FIG. 5. Referring to FIG. 9, the docking station main body 110 of the embodiment has a third section 114, and the portable device 52 has a magnetic portion 52d corresponding to the third section 114. When the portable device 52 is in the state as shown in FIG. 5 with the second tilt angle A2, the third section 114 is attached to the magnetic portion 52d, so that the portable device 52 may be supported more firmly on the docking station main body 110. The magnetic portion 52d described above may be such as a permanent magnet or other appropriate types of magnetic element, and the third section 114 may be such as a permanent magnet or other appropriate types of magnetic element.

FIG. 10 is a partial sectional view illustrating a docking station in FIG. 1. FIG. 11 is a schematic view illustrating a latching element latched with a portable device in FIG. 10. Referring to FIG. 10, in this embodiment, the flexible element 122 has an extension segment 122c. The extension segment 122c extends from a back side 110a of the docking station main body 110 of the docking station 100 along a bottom surface 110b of the docking station main body 110, and is fixed on the docking station main body 110. The connecting structure 120 further includes a latching element 129, and the latching element 129 is fixed at the extension segment 122c. When the portable device 52 closes on the docking station main body 110 as shown in FIG. 7, the latching element 129 is adapted to latch with the potable device 52 as shown in FIG. 11 to firmly fix the portable device 52.

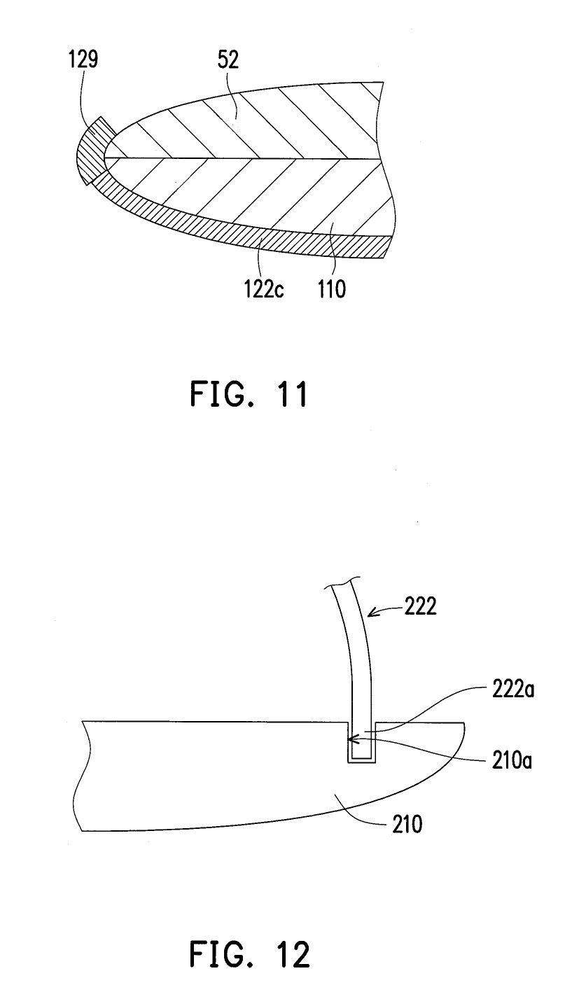

FIG. 12 is a partial view illustrating a docking station main body and a flexible element according to another embodiment of the invention. Referring to FIG. 12, the docking station main body 210 of the embodiment has a slot 210a and the flexible element 222 has an extension segment 222a. the extension segment 222a is inserted into the slot 210a to assemble the flexible element 222 to the docking station main body 210.

According to the above description, the connecting structure of the invention is adapted to be attached to the portable device and support the portable device on the docking station main body, and the portable device is adapted to be rotated by the bending of the flexible element to change the tilt angle or to close on the docking station main body. Since the portable device is rotated by the bending of the flexible element, thus it is not required to dispose a hinge structure on the docking station, so as to decrease the thickness of the portable device combined with the docking station and cut down on the manufacturing cost. In addition, the invention replaces the hinge structure with the flexible element to connect the docking station main body and the portable device, therefore, the portable device may be allowed to have more varieties of operation angle and position by the flexural characteristics of the flexible element. Furthermore, the connecting structure is utilized the adhesion, the pressure or the magnetism to attach to the portable device, therefore, the portable device is adapted to detach from the connecting structure to be in a detachable manner, so as to enhance the agility of utilizing

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A detachable assembled electronic device, comprising:
a portable device having a display interface; and
a docking station, comprising:
a docking station main body; and
a connecting structure, assembled to the docking station main body to support the portable device, and comprising:
a flexible element; and
a first section, wrapped by the flexible element, wherein when the first section is attached to the portable device, the first section and the flexible element are adapted to support the portable device on the docking station main body, and the portable device is adapted to rotate relative to the docking station main body by the bending of the flexible element to form an operation angle.

2. The detachable assembled electronic device as claimed in claim 1, wherein the portable device is adapted to close on the docking station main body by the bending of the flexible element.

3. The detachable assembled electronic device as claimed in claim 1, wherein the connecting structure further comprises a supporting element wrapped by the flexible element and connected to the first section by the flexible element.

4. The detachable assembled electronic device as claimed in claim 3, wherein the connecting structure further comprises a second section, and the second section is wrapped by the flexible element and located between the supporting element and the first section.

5. The detachable assembled electronic device as claimed in claim 4, wherein when both the first section and the second section are attached to the portable device, the portable device is adapted to have a first tilt angle by the support of the connecting structure, and when the first section is attached to the portable device and the second section is removed from the portable device by the bending of the flexible element, the portable device is adapted to have a second tilt angle by the support of the connecting structure.

6. The detachable assembled electronic device as claimed in claim 5, wherein the flexible element has a first bending portion and a second bending portion, the first bending portion is located between the first section and the second section, the second bending portion is located between the second section and the supporting element, when the portable device has the first tilt angle, the first bending portion is not bent and the second bending portion is bent, and when the portable device has the second tilt angle, both the first bending portion and the second bending portion are bent and the second bending portion is leaned against the docking station main body.

7. The detachable assembled electronic device as claimed in claim 5, wherein the docking station main body has a third section, and the portable device has a magnetic portion, and when the portable device has the second tilt angle, the third section is attached to the magnetic portion.

8. The detachable assembled electronic device as claimed in claim 4, wherein the first section and the second section have a silica gel or a magnetic substance for attaching to the docking station main body.

9. The detachable assembled electronic device as claimed in claim 4, wherein the portable device has two magnetic portions, the first section and the second section are respectively adapted to attach to the two magnetic portions.

10. The detachable assembled electronic device as claimed in claim 4, wherein the first section and the second section are attached to the docking station main body by an adhesion, a pressure or a magnetism.

11. The detachable assembled electronic device as claimed in claim 1, wherein the flexible element has an extension segment, and the extension segment extends from a back side of the docking station main body along a bottom surface of the docking station main body, and is fixed on the docking station main body.

12. The detachable assembled electronic device as claimed in claim 11, wherein the connecting structure further comprises a latching element, the latching element is fixed at the extension segment, and when the portable device closes on the docking station main body, the latching element is adapted to latch with the portable device.

13. The detachable assembled electronic device as claimed in claim 1, wherein the docking station main body has a slot, the flexible element has an extension segment, and the extension segment is inserted into the slot to assemble the flexible element to the docking station main body.

14. The detachable assembled electronic device as claimed in claim 1, wherein the docking station main body comprises an input interface.

15. A connecting structure for a detachable assembled electronic device, adapted to assemble to a docking station main body and attach to a portable device having a display interface, the connecting structure for the detachable assembled electronic device comprises:
a flexible element; and
a first section, wrapped by the flexible element, wherein when the first section is attached to the portable device, the first section and the flexible element are adapted to support the portable device on the docking station main body, and the portable device is adapted to rotate relative to the docking station main body by the bending of the flexible element to form an operation angle.

16. The connecting structure for the detachable assembled electronic device as claimed in claim 15, wherein the portable device is adapted to close on the docking station main body by the bending of the flexible element.

17. The connecting structure for the detachable assembled electronic device as claimed in claim 15, further comprising a supporting element wrapped by the flexible element and connected to the first section by the flexible element.

18. The connecting structure for the detachable assembled electronic device as claimed in claim 17, further comprising a second section, and the second section is wrapped by the flexible element and located between the supporting element and the first section.

19. The connecting structure for the detachable assembled electronic device as claimed in claim 18, wherein when both the first section and the second section are attached to the portable device, the portable device is adapted to have a first tilt angle by the support of the connecting structure, and when the first section is attached to the portable device and the second section is removed from the portable device by the bending of the flexible element, the portable device is adapted to have a second tilt angle by the support of the connecting structure.

20. The connecting structure for the detachable assembled electronic device as claimed in claim 19, wherein the flexible element has a first bending portion and a second bending portion, the first bending portion is located between the first section and the second section, the second bending portion is located between the second section and the supporting element, when the portable device has the first tilt angle, the first bending portion is not bent and the second bending portion is bent, and when the portable device has the second tilt angle, both the first bending portion and the second bending portion are bent and the second bending portion is leaned against the docking station main body.

21. The connecting structure for the detachable assembled electronic device as claimed in claim 19, wherein the docking station main body has a third section, and the portable device has a magnetic portion, and when the portable device has the second tilt angle, the third section is attached to the magnetic portion.

22. The connecting structure for the detachable assembled electronic device as claimed in claim 18, wherein the first section and the second section have a silica gel or a magnetic substance for attaching to the docking station main body.

23. The connecting structure for the detachable assembled electronic device as claimed in claim 18, wherein the portable device has two magnetic portions, the first section and the second section are respectively adapted to attach to the two magnetic portions.

24. The connecting structure for the detachable assembled electronic device as claimed in claim 18, wherein the first section and the second section are attached to the docking station main body by an adhesion, a pressure or a magnetism.

25. The connecting structure for the detachable assembled electronic device as claimed in claim 15, wherein the flexible element has an extension segment, and the extension segment extends from a back side of the docking station main body along a bottom surface of the docking station main body, and is fixed on the docking station main body.

26. The connecting structure for the detachable assembled electronic device as claimed in claim 25, further comprising a latching element, the latching element is fixed at the extension segment, and when the portable device closes on the docking station main body, the latching element is adapted to latch with the portable device.

27. The connecting structure for the detachable assembled electronic device as claimed in claim 15, wherein the docking station main body has a slot, the flexible element has an extension segment, and the extension segment is inserted into the slot to assemble the flexible element to the docking station main body.

28. The connecting structure for the detachable assembled electronic device as claimed in claim 15, wherein the docking station main body comprises an input interface.
